(19) United States
(12) Patent Application Publication
(10) Pub. No.: US 2006/0169903 A1
(43) Pub. Date: Aug. 3, 2006

(54) Infrared sensor unit for controlling operation of electrically powered appliances

(76) Inventor: Ali Pascal Mahvi, Novelty, OH (US)

Correspondence Address: STETINA BRUNDA GARRED & BRUCKER, 75 ENTERPRISE, SUITE 250, ALISO VIEJO, CA, 92656, US

(21) Appl. No.: 11/390,867

(22) Filed: Mar. 28, 2006

Related U.S. Application Data
(63) Continuation of application No. 10/448,011, filed on May 29, 2003, now abandoned.

(51) Int. Cl. G01J 5/00

(52) U.S. Cl. 250/338.3

(57) ABSTRACT

There is provided an infrared sensor unit for deactivating an electrical appliance when left unattended by its user. The sensor unit includes a passive infrared sensor for sensing the user through a field of infrared light provided within a viewable distance of the electrical appliance. An adjustable timer is in electrical communication with the passive infrared sensor for counting toward a predetermined amount of time when the user is not sensed within the field of infrared light. The sensor unit further includes a controller device which is in electrical communication with the adjustable timer for deactivating the electrical appliance upon reaching the predetermined amount of time.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to sensor units, and more particularly to an improved sensor unit which creates and utilizes a field of infrared light to detect changes in motion and/or body temperature of a user for automatically deactivating a nearby electrical appliance such as a television set based thereon.

Energy conservation is an important concept to follow in today's world. This is particularly the case for certain forms of energy which possess such a high value that the society as a whole becomes extremely dependent upon their use for everyday function. Put it simply, the availability of and access to these forms of energy is vital for the survival of the modern world as we know it.

In today's technological world, perhaps none is more important than electricity. This valuable form of energy powers thousands of electrical devices and appliances throughout the world which are necessary to conduct daily activities. This is readily demonstrated in an average home, for instance, which relies on electricity to power and operate a myriad of household appliances such as audio and video equipments, washer and dryer machines, various kitchen and bathroom instruments, and the like.

Due to the society's continuous and overwhelming dependence on electricity, it is simply unimaginable to live without electricity. However, electricity is a limited resource that requires massive manpower and effort to generate. When electric power plants fail to generate and supply sufficient amount of electricity which is often the case, untoward consequences such as power blackouts and inflated utility prices typically result. These are inevitably passed on to the consumers who have no choice but to bear and grind through such circumstances.

As such, it is obviously important to conserve electricity to prevent the occurrences of blackouts and inflated prices. One effective measure against such occurrences is to conserve electricity in situations that do not absolutely require its usage. Perhaps none fits this profile better than television sets which are prevalent in an average home.

Typically, an average home in today's society contains multiple sets of television to accommodate the needs of various family members residing therein. One or more of these television sets in an average home are oftentimes turned on throughout most of the day. The amount of electricity that is required to activate and operate these television sets may be significant when considering the enormous number of households existing throughout the world.

Waste of electricity often arises when these television sets remain turned on despite their nonuse. More specifically, it is repeatedly the case that their users forget to turn off the television sets when they fall asleep, or leave the room or house. This obviously results in unnecessary wastes in electricity which can lead to dire consequences such as power blackouts and inflated utility prices. As such, simply turning off unused or unviewed television sets can serve as an effective measure in conserving electricity.

In order to counter such problem associated with television usage, sleeper mode functions have been incorporated into many television sets that are currently available in the marketplace. However, they are effective only to the extent that their users actively preset the television sets prior to falling asleep or leaving the premise. Simply put, such sleeper modes cannot perform their intended functions unless the users conscientiously preset them before sleeping or leaving, which are often forgotten or neglected.

In view of the above-described shortcomings of conventional electrically powered appliances, there exists a need in the art for a controller system that can automatically deactivate an electrical appliance such as a television set when it is not in use. More specifically, there exists a need for a controller system which can perform such intended function in a user-friendly manner without the hassles associated with repetitive presetting and/or any form of conscientious programming directed toward deactivation.

### BRIEF SUMMARY OF THE INVENTION

The present invention specifically addresses and alleviates the above-referenced deficiencies associated with the use of the electrically powered appliances of the prior art. More particularly, the present invention is a sensor unit which utilizes a field of infrared light to detect changes in motion and/or body temperature of a user for automatically deactivating a nearby television set when it is not in use. As will be demonstrated below, the present sensor unit's ability to automatically deactivate an unused or unviewed television set results in conservation of electricity without requiring any conscientious and/or active intervention by its users.

Although the sensor unit of the present invention is preferably used to control the operation of a television set, it should be expressly recognized herein that its application may be extended to other types of electrically powered devices. For example, the present sensor unit may be employed to automatically deactivate an air conditioning system or a household appliance such as an audio system or electric kitchen stove when no users are detected within a certain selected vicinity for a certain predetermined time. Put it simply, there is no limitation as to the application of the present sensor unit in relation to its operability with electrically powered devices.

In accordance with a preferred embodiment of the present invention, there is provided a sensor unit for automatically deactivating an unused or unviewed television set. The sensor unit of the present invention first features a passive infrared sensor (“PIR”) sensor for generating infrared light. The sensor unit is preferably placed about the proximity of the television set such that its PIR sensor can emanate a field of infrared light within a viewable distance thereof (e.g., approximately 25 feet).

Although various types of sensors may be incorporated into the sensor unit of the present invention, it is specifically contemplated herein that the sensor of choice is the PIR sensor as it can optimally detect changes in the user's motion and/or body temperature. One notable type of PIR sensor which fits this description and is currently made available in the marketplace is Model No. KC7789 from COMedia Limited located in Hong Kong, China.

The sensor unit of the present invention preferably includes an aperture device for facilitating the detection of the user's body temperature change by the PIR sensor. More precisely, the aperture device is adapted to close the PIR sensor from the heat generated from the user's body. In this respect, the PIR sensor can be allowed to better detect the change in the user's body temperature and realize his or her presence within the viewable distance of the television set.

It should be indicated herein that the use of the aperture device is not absolutely required to achieve the intended objective of the present invention as the PIR sensor may merely sense the body temperature to determine the user's presence. However, its use is recommended as the aperture device allows the PIR sensor to account for certain situations in which the user maintains a constant body temperature such as when he or she falls asleep in front of the television set.

In the preferred embodiment of the present invention, the sensor unit also features an adjustable timer for keeping track of time in which the television set is left unattended or unused by its user. The adjustable timer is placed in electrical communication with the PIR sensor and is operative to count toward a predetermined amount of time set for deactivation whenever the PIR sensor fails to detect any change in motion and/or body temperature of the user.

Should the PIR sensor detect the user through his or her change of motion and/or body temperature within its generated field of infrared light, the adjustable timer is configured to reset and recount the predetermined amount of time for deactivation of the television set. Preferably, the predetermined amount of time is selectively adjustable between about 5 minutes and about 24 hours, and more preferably between about 15 minutes and 60 minutes.

In accordance with a preferred embodiment of the present invention, the sensor unit further features a controller device for deactivating the television set when the PIR sensor fails to sense the user's presence during the predetermined amount of time. In order to perform this function, the controller device is disposed in electrical communication with the adjustable timer so that it becomes actuated only upon reaching the designated timing to terminate or interrupt the power to the television set. As will be better explained below, the controller device may be placed either in wired or wireless communication with the television set for its deactivation.

In one aspect of the present invention, the controller device is preferably a power delivery circuit which is disposed in wired communication with the television set. More specifically, they are in wired communication with each other in the sense that the power cord of the television set is plugged into the power delivery circuit. For the sake of this invention, various conventional or standard power delivery circuits may be used with the present sensor unit.

The power delivery circuit includes a power termination/interruption switch which can be activated to terminate or interrupt power to the television set. Upon the sensor unit's failure to detect any change in the user's motion and/or body temperature for a predetermined amount of time as specified above, the power termination/interruption switch operates to cut off the power flowing to the television set, and thus deactivating the same.

In an alternate aspect of the present invention, the controller device is preferably a standard or conventional remote control transmitter which is placed in wireless communication with the television set. In the preferred embodiment, the remote control transmitter is either an infrared or radiofrequency transmitter which utilizes infrared or radiofrequency beams to wirelessly control the operations of the television set.

Similar to the first discussed version of the controller device, the remote control transmitter may incorporate the use of a power termination/interruption switch for deactivating the television set. Of course, as one of ordinary skill in the art will appreciate, the remote control transmitter should be programmable to correspond to the specifications of the television set, thus being compatible for use therewith.

In the preferred embodiment of the present invention, the sensor unit may include a voice command module for controlling various operations of the television set through versatile voice applications (e.g., switch channels, voice deactivation, screen adjustment, etc.). It should be specifically noted herein that this feature of the invention is strictly optional and is not a required element to accomplish the primary objective of the present invention. By providing such feature, different aspects of the television set may be controlled simply by the use of the user's voice, thus providing a more comprehensive and user-friendly management of the television set.

Although various types of voice command modules may be utilized for such purpose, it is preferred that the voice command module of the present invention is a single-chip voice synthesizer LSI. One type of single-chip voice synthesizer which may be suited for use with the present invention is the EasyVoice™ Speech module currently available from COMedia Limited of Hong Kong, China.

In operation, the sensor unit of the present invention is provided for automatically deactivating an unused or unviewed television set. The present sensor unit is strategically positioned in relation to the television set such that it can radiate a field of infrared light within a viewable distance of the television set. Although the sensor unit is essentially described to be an after-market or retrofitted product, a person of ordinary skill in the art will recognize that it may be incorporated into the television set upon manufacture so as to be availed as one composite electronic system.

The field of infrared light generated within the viewable distance of the television set detects the user's change in motion and/or heat resulting from his or her body temperature which occur therewithin. The continuous detection of the user's presence through such manner triggers the adjustable timer to be reset so as to maintain the activation of the television set. However, upon failing to detect any change in motion or body temperature of the user, the adjustable timer counts toward the predetermined amount of time for deactivation and does not reset to restart that timing.

Upon reaching the designated timing for deactivation, the sensor unit of the present invention deactivates the television set by terminating or interrupting the power flowing thereto. Once the television set is turned off, the reappearance of the user within the generated field of infrared light does not reactivate the television set. Rather, the user should manually reactivate the television set which in turn causes the operation of the present sensor unit once again. In this regard, the whole process of deactivating the television set may be repeated in order to fulfill the ultimate objective of conserving electricity.

### BRIEF DESCRIPTION OF THE DRAWINGS

These as well as other features of the present invention will become more apparent upon reference to the drawings wherein:

FIG. 1 is a block diagram of an infrared sensor unit constructed in accordance with a preferred embodiment of the present invention and illustrating its power delivery circuit which controls the operation of a nearby electrical appliance via a wired communication; and

FIG. 2 is a block diagram of an infrared sensor unit constructed in accordance with an alternate preferred embodiment of the present invention and illustrating its remote control transmitter which controls the operation of a nearby electrical appliance via a wireless communication.

### DETAILED DESCRIPTION OF THE INVENTION

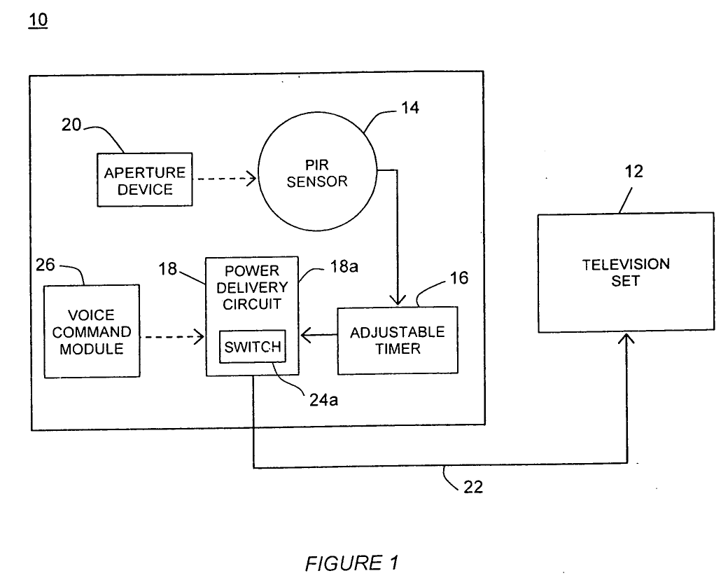

Referring now to the drawings wherein the showings are for purposes of illustrating preferred embodiments of the present invention only, and not for purposes of limiting the same, FIG. 1 illustrates an infrared sensor unit 10 constructed in accordance with a preferred embodiment of the present invention. As indicated above, the present sensor unit 10 utilizes a field of infrared light to detect changes in motion and/or body temperature of a user for automatically deactivating a television set 12 when it is unused or unviewed. As will be soon discussed, this ability to automatically deactivate an unused or unviewed television set 12 results in an advantageous and positive benefit of conserving electricity without requiring any conscientious and/or active intervention by its users.

Prior to describing the specific details of the present invention, it should be expressly stated herein that the application of the present sensor unit 10 may be broadened to include other types of electrically powered devices. For example, the sensor unit 10 of the present invention may be utilized for automatically deactivating an air conditioning system of a residential house or commercial building. Its further application may also include household appliances such as an audio system, electric kitchen stove, food mixer and the like so as to implement their deactivation when no users are detected within a certain selected vicinity for a certain predetermined time. Simply put, the application of the present sensor unit 10 should be construed broadly, rather than narrowly, to include its operability with various electrically powered devices.

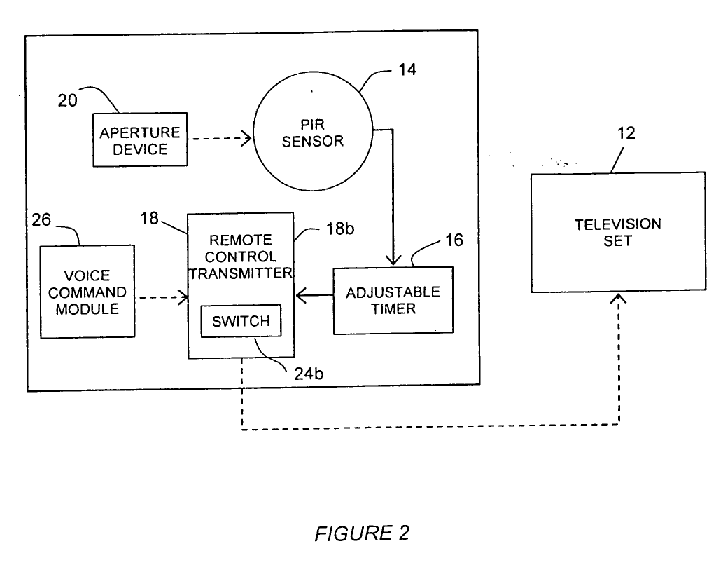

Referring more particularly to FIGS. 1 and 2, the infrared sensor unit 10 of the present invention is essentially comprised of a passive infrared sensor (“PIR”) sensor 14, an adjustable timer 16 and a controller device 18. In particular, the PIR sensor 14 is provided to generate or create infrared light for sensing the user's presence. More particularly, the infrared sensor unit 10 is preferably placed about the proximity of the television set 12 such that the PIR sensor 14 can radiate or emanate a field of infrared light within a viewable distance of the television set 12. An exemplary viewable distance may be approximately 25 feet from the television set 12 but in no way should be limited thereto.

It should be noted that although various types of sensors may be used within the sensor unit 10 of the present invention, the sensor of choice is nonetheless the PIR sensor 14. The PIR sensor 14 is preferred because it provides the desired field of infrared light which can effectively detect changes in the user's motion and/or body temperature. One specific type of PIR sensor 14 which is workable and fits such desired specification is Model No. KC7789 which is currently made available in the marketplace by COMedia Limited, a corporation located in Hong Kong, China.

In the preferred embodiment, the infrared sensor unit 10 of the present invention comprises an aperture device 20 for the purpose of facilitating the detection of the user's body temperature change by the PIR sensor 14. More specifically, this aperture device 20 is adapted to essentially close the PIR sensor 14 from the heat generated from the user's body. This allows the PIR sensor 14 to better detect the change in the user's body temperature and recognize his or her presence within the viewable distance (e.g., approximately 25 feet) of the television set 12.

The use of the aperture device 20 is not absolutely necessary to accomplish the primary objective of the present invention. Rather, the aperture device 20 may be left out so that the PIR sensor 14 is configured to merely sense the body temperature of the user to determine his or her presence. However, its incorporation into the infrared sensor unit 10 of the present invention is preferred since the aperture device 20 allows the PIR sensor 14 to account for certain situations in which the user maintains a constant body temperature. An example illustrating such situation may be when the user falls asleep or takes a nap in front of the television set 12 as it is often done in the real world.

As briefly indicated above, the infrared sensor unit 10 of the present invention comprises an adjustable timer 16 in addition to the PIR sensor 14. The adjustable timer 16 is essentially provided to keep track of time in which the television set 12 is left unattended or unused by its user. As to its interconnection, the adjustable timer 16 is placed in electrical communication with the PIR sensor 14. By doing so, the adjustable timer 16 is operative to count toward a predetermined amount of time set for deactivation whenever the PIR sensor 14 is not able to detect any change in the motion and/or body temperature of the user.

When the PIR sensor 14 detects user's presence through his or her change of motion and/or body temperature within its provided field of infrared light, the adjustable timer 16 is adapted to reset and recount the predetermined amount of time for deactivation of the television set 12. The predetermined amount of time for deactivation may be chosen and subsequently adjusted to be any measure of time. Preferably, however, the predetermined amount of time for deactivation is selectively adjustable between about 5 minutes and about 24 hours, and more preferably between about 15 minutes and 60 minutes.

In addition to the two specific components described above, the infrared sensor unit 10 of the present invention further comprises a controller device 18. Essentially, the controller device 18 is provided for deactivating the television set 12 when the PIR sensor 14 fails to sense or detect the user's presence during the predetermined amount of time. In order to carry out its objective, the controller device 18 is placed in electrical communication with the adjustable timer 16. By such connection to the adjustable timer 16, the controller device 18 may become actuated upon reaching the designated timing for deactivation to terminate or interrupt the power to the television set 12. As will be better explained below, the controller device 18 may be placed either in wired or wireless communication with the television set 12 so as to be able to regulate its deactivation.

Referring now to FIG. 1 only, the controller device 18 is preferably a power delivery circuit 18a in one aspect of the present invention. The power delivery circuit 18a is placed in wired electrical communication with the television set 12. More precisely, the television set 12 and the power delivery circuit 18a is in wired communication with each other to the extent that the power cord 22 of the television set 12 is plugged into the power delivery circuit 18a. For the sake of this invention, various conventional or standard power delivery circuits 18a may be utilized with the infrared sensor unit 10 of the present invention.

The power delivery circuit 18a includes a power. termination/interruption switch 24a which is essentially provided for terminating or interrupting any power going into the television set 12. Upon the sensor unit's failure to detect any change in the user's motion and/or body temperature for a predetermined amount of time as specified above, the power termination/interruption switch 24a becomes activated and operates to cut off the power flowing to the television set 12. Hence, the television set 12 may become deactivated thereby.

Referring now to FIG. 2 only, the controller device 18 is preferably a remote control transmitter 18b. Various standard or conventional remote control transmitters may be utilized for this purpose. In particular, the remote control transmitter 18b is placed in wireless communication with the television set 12. In the present invention, the remote control transmitter 18b may be an infrared remote transmitter, or alternatively a radiofrequency remote transmitter. In this respect, the remote control transmitter 18b may utilize either infrared or radiofrequency beams to wirelessly control the operations of the television set 12.

Similar to the first discussed version of the controller device 18, the remote control transmitter 18b may incorporate the use of its own power termination/interruption switch 24b for deactivating the television set 12. Of course, as one of ordinary skill in the art will appreciate, the remote control transmitter 18b should be a programmable one so as to correspond to the specifications of the television set 12. Put simply, the remote control transmitter 18b should be programmable to be compatible for use with the television set 12.

Referring now back to FIGS. 1 and 2, the infrared sensor unit 10 of the present invention may optionally include a voice command module 26 for controlling various operations of the television set 12 through versatile voice applications. For example, the voice command module 26 may be used to switch between television channels. Alternatively or in addition to such example, the voice command module 26 may contribute to the deactivation of the television set 12 through voice command, or adjust or modify the screening of the television set 12. Other similar types of functioning are contemplated herein.

It should be expressed that the use of the voice command module 26 is strictly optional and is not a required element to accomplish the primary objective of the present invention. By providing such optional feature, different aspects of the television set 12 may be controlled simply by the use of the user's voice. Obviously, this would provide a more comprehensive, convenient and user-friendly management of the television set 12.

Although various types of voice command modules 26 may be utilized with the present invention, the presently used voice command module 26 is preferably a single-chip voice synthesizer LSI. One notable type of single-chip voice synthesizer which may be suited for use with the infrared sensor unit 10 of the present invention is the EasyVoice™ Speech module currently manufactured and made available by CoMedia Limited located in Hong Kong, China.

In operation, the infrared sensor unit 10 of the present invention is provided and used for automatically deactivating an unused or unviewed television set 12. The present sensor unit 10 is strategically positioned in relation to the television set 12 such that it can radiate a field of infrared light within a viewable distance (e.g., approximately 25 feet) of the television set 12. Although the infrared sensor unit 10 is essentially described to be an after-market or retrofitted product, a person of ordinary skill in the art will recognize that it may be incorporated into the television set 12 upon manufacture so as to be availed as one composite electronic system.

The field of infrared light generated within the viewable distance of the television set 12 detects the user's change in motion and/or heat resulting from his or her body temperature which occur therewithin. The continuous detection of the user's presence through such manner triggers the adjustable timer 16 to be reset so as to maintain the activation of the television set 12. However, upon failing to detect any change in motion or body temperature of the user, the adjustable timer 16 counts toward the predetermined amount of time for deactivation of the television set 12 and does not reset to restart that timing.

Upon reaching the designated timing for deactivation, the infrared sensor unit 10 of the present invention deactivates the television set 12 by terminating or interrupting the power flowing thereto. Once the television set 12 is turned off, the reappearance of the user within the generated field of infrared light does not reactivate the television set 12. Rather, the user should manually reactivate the television set 12 which in turn causes the operation of the present infrared sensor unit 10 once again. In this regard, the whole process of deactivating the television set 12 may be repeated in order to fulfill the ultimate objective of conserving electricity.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A sensor unit for deactivating an electrical appliance when left unattended by a user, the sensor unit comprising:
a passive infrared sensor for sensing the user through a field of infrared light provided within a viewable distance of the electrical appliance;
an adjustable timer in electrical communication with the passive infrared sensor for counting toward a predetermined amount of time when the user is not sensed within the field of infrared light;
a controller device being in electrical communication with the adjustable timer and the electrical appliance, the controller being operative to deactivate the electrical appliance upon the adjustable timer reaching the predetermined amount of time; and
a voice command module being operative to receive a command from the user, the voice command module being in communication with the electrical appliance to transmit the command to the electrical appliance, the electrical appliance performing a given operation in response to the command, the given operation including deactivation of the appliance the given operation being performed independently of the adjustable timer.

2. The sensor unit of claim 1 wherein the passive infrared sensor senses a change in motion of the user within the field of infrared light.

3. The sensor unit of claim 2 wherein the adjustable timer counts toward the predetermined amount of time when the passive infrared sensor fails to sense the change in motion of the user.

4. The sensor unit of claim 3 wherein the adjustable timer recounts the predetermined amount of time when the passive infrared sensor senses the change in motion of the user.

5. The sensor unit of claim 1 wherein the passive infrared sensor senses a change in heat generating from a body temperature of the user within the field of infrared light.

6. The sensor unit of claim 5 wherein the adjustable timer counts toward the predetermined amount of time when the passive infrared sensor fails to sense heat generating from the body temperature of the user.

7. The sensor unit of claim 5 wherein the adjustable timer counts toward the predetermined amount of time when the passive infrared sensor fails to sense the change in heat generating from the body temperature of the user.

8. The sensor unit of claim 5 wherein the adjustable timer recounts the predetermined amount of time when the passive infrared sensor senses the change in heat generating from the body temperature of the user.

9. The sensor unit of claim 5 further comprising an aperture device for closing the passive infrared sensor from heat generated from the body temperature of the user.

10. (canceled)

11. (canceled)

12. The sensor unit of claim 1 wherein the controller device terminates power to the electrical appliance upon reaching the predetermined amount of time.

13. The sensor unit of claim 1 wherein the controller device interrupts power to the electrical appliance upon reaching the predetermined amount of time.

14. The sensor unit of claim 1 wherein the controller device is in a wired communication with the electrical appliance.

15. The sensor unit of claim 14 wherein the controller device is a power delivery circuit with a power termination/interruption switch.

16. The sensor unit of claim 1 wherein the controller device is in a wireless communication with the electrical appliance.

17. The sensor unit of claim 16 wherein the controller device is a radiofrequency remote control transmitter with a power termination/interruption switch.

18. The sensor unit of claim 16 wherein the controller device is an infrared remote control transmitter with a power termination/interruption switch.

19. (canceled)

20. The sensor unit of claim 1 wherein the voice command module is a single-chip voice synthesizer LSI.

21. The sensor unit of claim 1 wherein the given operation includes changing a channel of the appliance.

22. The sensor unit of claim 21 wherein the electrical appliance is a television set.

23. An infrared sensor unit for controlling an operation of an electrical appliance by a user, the sensor unit comprising:
a passive infrared sensor for sensing the user through a field of infrared light provided within a viewable distance of the electrical appliance;
an aperture device disposed on the passive infrared sensor, the aperture device being operative to close the passive infrared sensor from heat generated from the body temperature of the user;
an adjustable timer in electrical communication with the passive infrared sensor for counting toward a predetermined amount of time when the user is not sensed within the field of infrared light;
a controller device being in electrical communication with the adjustable timer and in wireless communication with the electrical appliance, the controller being operative to deactivate the electrical appliance upon the adjustable timer reaching the predetermined amount of time; and
a voice command module being operative to receive a command from the user, the voice command module being in communication with the electrical appliance to transmit the command to the electrical appliance, the electrical appliance performing a given operation in response to the command, the given operation including deactivation of the appliance, the given operation being performed independently of the adjustable timer.

24. A method of controlling a given operation of an electrical appliance utilizing an infrared sensor unit, the method comprising:
receiving a command from the user utilizing a voice command module of the infrared sensor unit, the voice command module being in communication with the electrical appliance;
transmitting the command from the voice command module to the electrical appliance; and
performing the given operation of the electrical appliance in response to the command, the given operation including deactivating the appliance.

25. The method of claim 24 wherein the given operation includes changing a channel of the appliance.

26. The method of claim 25 wherein the electrical appliance is a television set.
